(19) United States
(12) Patent Application Publication
(10) Pub. No.: US 2026/0107228 A1
(43) Pub. Date: Apr. 16, 2026

(54) LOW-POWER WAKE-UP SIGNAL WITH AUTOMATIC GAIN CONTROL INFORMATION

(71) Applicant: QUALCOMM Incorporated, San Diego, CA (US)

(72) Inventors: Jung Ho RYU, Englewood Cliffs, NJ (US); Igor GUTMAN, Hod HaSharon (IL); Kazuki TAKEDA, Minato-ku (JP); Jelena DAMNJANOVIC, Del Mar, CA (US); Tao LUO, San Diego, CA (US)

(21) Appl. No.: 19/294,413

(22) Filed: Aug. 8, 2025

Related U.S. Application Data
(60) Provisional application No. 63/706,371, filed on Oct. 11, 2024.

(51) Int. Cl. H04W 52/02; H04W 52/52

(52) U.S. Cl. CPC H04W 52/0235; H04W 52/52

(57) ABSTRACT

Various aspects of the present disclosure generally relate to wireless communication. In some aspects, a user equipment (UE) may receive, using a low-power wake-up radio (LP-WUR), a low-power wake-up signal (LP-WUS) in a set of symbols, wherein the set of symbols includes a first subset of the set of symbols and a second subset of the set of symbols occurring after the first subset of the set of symbols, wherein control information is conveyed starting at the second subset of the set of symbols. The UE may communicate, using a main radio, in accordance with the LP-WUS. Numerous other aspects are described.

### CROSS-REFERENCE TO RELATED APPLICATION

This Patent Application claims priority to U.S. Provisional Ser. No. 63/706,371, filed on Oct. 11, 2024, entitled “LOW-POWER WAKE-UP SIGNAL WITH AUTOMATIC GAIN CONTROL INFORMATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with a low-power (LP) wake-up signal (WUS) (LP-WUS) with automatic gain control (AGC) information.

### BACKGROUND

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include receiving, using a low-power wake-up radio (LP-WUR), a low-power wake-up signal (LP-WUS) in a set of symbols, wherein the set of symbols includes a first subset of the set of symbols and a second subset of the set of symbols occurring after the first subset of the set of symbols, wherein control information is conveyed starting at the second subset of the set of symbols. The method may include communicating, using a main radio, in accordance with the LP-WUS.

Some aspects described herein relate to a method of wireless communication performed by a network node. The method may include transmitting an LP-WUS in a set of symbols, wherein the set of symbols includes a first subset of the set of symbols and a second subset of the set of symbols occurring after the first subset of the set of symbols, wherein control information is conveyed starting at the second subset of the set of symbols, wherein the LP-WUS is a first type of modulation signal for reception by a first type of radio. The method may include communicating, using a second type of modulation signal for reception by a second type of radio, in accordance with the LP-WUS.

Some aspects described herein relate to a UE for wireless communication. The user equipment may include one or more memories and one or more processors coupled to the one or more memories. The one or more processors may be configured to receive, using an LP-WUR, an LP-WUS in a set of symbols, wherein the set of symbols includes a first subset of the set of symbols and a second subset of the set of symbols occurring after the first subset of the set of symbols, wherein control information is conveyed starting at the second subset of the set of symbols. The one or more processors may be configured to communicate, using a main radio, in accordance with the LP-WUS.

Some aspects described herein relate to a network node for wireless communication. The network node may include one or more memories and one or more processors coupled to the one or more memories. The one or more processors may be configured to transmit an LP-WUS in a set of symbols, wherein the set of symbols includes a first subset of the set of symbols and a second subset of the set of symbols occurring after the first subset of the set of symbols, wherein control information is conveyed starting at the second subset of the set of symbols, wherein the LP-WUS is a first type of modulation signal for reception by a first type of radio. The one or more processors may be configured to communicate, using a second type of modulation signal for reception by a second type of radio, in accordance with the LP-WUS.

Some aspects described herein relate to a non-transitory computer-readable medium that stores a set of instructions for wireless communication by a UE. The set of instructions, when executed by one or more processors of the UE, may cause the UE to receive, using an LP-WUR, an LP-WUS in a set of symbols, wherein the set of symbols includes a first subset of the set of symbols and a second subset of the set of symbols occurring after the first subset of the set of symbols, wherein control information is conveyed starting at the second subset of the set of symbols. The set of instructions, when executed by one or more processors of the UE, may cause the UE to communicate, using a main radio, in accordance with the LP-WUS.

Some aspects described herein relate to a non-transitory computer-readable medium that stores a set of instructions for wireless communication by a network node. The set of instructions, when executed by one or more processors of the network node, may cause the network node to transmit an LP-WUS in a set of symbols, wherein the set of symbols includes a first subset of the set of symbols and a second subset of the set of symbols occurring after the first subset of the set of symbols, wherein control information is conveyed starting at the second subset of the set of symbols, wherein the LP-WUS is a first type of modulation signal for reception by a first type of radio. The set of instructions, when executed by one or more processors of the network node, may cause the network node to communicate, using a second type of modulation signal for reception by a second type of radio, in accordance with the LP-WUS.

Some aspects described herein relate to an apparatus for wireless communication. The apparatus may include means for receiving, using an LP-WUR, an LP-WUS in a set of symbols, wherein the set of symbols includes a first subset of the set of symbols and a second subset of the set of symbols occurring after the first subset of the set of symbols, wherein control information is conveyed starting at the second subset of the set of symbols. The apparatus may include means for communicating, using a main radio, in accordance with the LP-WUS.

Some aspects described herein relate to an apparatus for wireless communication. The apparatus may include means for transmitting an LP-WUS in a set of symbols, wherein the set of symbols includes a first subset of the set of symbols and a second subset of the set of symbols occurring after the first subset of the set of symbols, wherein control information is conveyed starting at the second subset of the set of symbols, wherein the LP-WUS is a first type of modulation signal for reception by a first type of radio. The apparatus may include means for communicating, using a second type of modulation signal for reception by a second type of radio, in accordance with the LP-WUS.

Aspects of the present disclosure may generally be implemented by or as a method, apparatus, system, computer program product, non-transitory computer-readable medium, user equipment, base station, network node, network entity, wireless communication device, or processing system as substantially described with reference to, and as illustrated by, this specification and accompanying drawings and appendix.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating an example of a low-power wakeup radio (LP-WUR) and a low-power wakeup signal (LP-WUS).

FIGS. 4A and 4B is a diagram illustrating an example associated with LP-WUS indication with automatic gain control information.

FIG. 5 is a diagram illustrating an example process performed, for example, at a user equipment (UE) or an apparatus of a UE.

FIG. 6 is a diagram illustrating an example process performed, for example, at a network node or an apparatus of a network node.

FIG. 7 is a diagram of an example apparatus for wireless communication.

FIG. 8 is a diagram of an example apparatus for wireless communication.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures or functionalities in addition to or other than the structures or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A wireless communication system may provide for communications between a network node and a user equipment (UE). These communications may consume some amount of power. For example, a UE may consume a lower amount of power while in a low power state (such as while not connected to a network or while waiting for paging from the network), and may consume a higher amount of power while in a full power state (such as while actively communicating with a network node or while monitoring for control information from the network). Certain components of the UE may consume a significant amount of power. For example, a main radio of the UE, which may support bidirectional communication (such as both transmission and reception), multi-layer communication, or larger bandwidths (such as a communication bandwidth of the UE), may consume power while active, such as in the course of communicating or monitoring for control information.

Some techniques provide power savings at the UE by limiting the amount or ratio of time in which the main radio is active, relative to the amount of time in which the main radio is inactive or powered down. For example, a connected mode discontinuous reception (C-DRX) cycle may provide off durations (sometimes referred to as inactive times or sleep durations) in which the main radio is inactive, and on durations (sometimes referred to as active times or wake durations) in which the main radio is active. The UE may monitor for a physical downlink control channel (PDCCH) (or another control channel or data channel) communication during an on duration, and may extend the on duration if a PDCCH communication is received, which facilitates further communication in accordance with the PDCCH communication. Thus, power consumption of the main radio may be reduced by reducing the amount of time in which the main radio is active or monitoring for a PDCCH communication.

While the C-DRX cycle reduces power consumption at the UE and the network, further power savings may be desirable, particularly in 5G, 6G, and similar radio access technologies (RATs) where beamforming and high-frequency communication cause increased power consumption relative to other RATs. To achieve further power savings, a UE may include or be associated with a second, low-power wakeup radio (LP-WUR). Relative to a non-LP-WUR (e.g., the main radio of the UE), the LP-WUR may have reduced power consumption. For example, the LP-WUR may be configured with a reduced bandwidth, reduced processing capabilities, or other reduced capabilities, relative to a main radio, which facilitate operation with reduced power consumption. In one particular example, the LP-WUR may be configured to use an envelope detector type of receiver architecture, with on-off keying (OOK) modulation, to enable a UE to perform signaling monitoring with low power consumption.

The LP-WUR may facilitate indication, from the network, for the UE to exit a low power state, such as by waking up the main radio. For example, while the main radio is in a low power state, the LP-WUR may receive a signal referred to as a low-power wakeup signal (LP-WUS), and may trigger the main radio to exit the low power state and may trigger a UE to transfer from an idle mode to an active mode to receive PDCCH paging. In another example, when a UE is operating in a connected mode, the LP-WUS may trigger UE PDCCH monitoring. In some configurations, the LP-WUS/LP-WUR can be implemented in conjunction with a C-DRX cycle, such that the main radio may skip an on duration if the LP-WUR has not received an LP-WUS in association with (e.g., before) the on duration, thereby further reducing power consumption relative to waking up in an on duration in which the UE will not receive a PDCCH communication.

When a UE receives an LP-WUS, the UE may convert the LP-WUS from an analog format to a digital format (e.g., using an analog to digital converter (ADC)). The ADC may have a range of signal power values for which the ADC can convert analog signals to digital signals. Accordingly, to convert a signal from an analog signal to a digital signal, the UE applies a gain to the analog signal to cause a signal power of the analog signal to be within the range of signal power values of the AGC. For example, when an amplitude of the analog signal is too low, the UE applies a positive gain and when an amplitude of the analog signal is too high, the UE applies a negative gain. Such a process may be referred to as “automatic gain control” or “AGC” operation. However, a LP-WUR of the UE may have limited capabilities for performing AGC operation.

Various aspects relate generally to an LP-WUS with AGC information. Some aspects more specifically relate to an LP-WUS transmitted across a plurality of communication resources, with a subset of communication resources being repeated to provide for AGC operation. For example, a network node may transmit an LP-WUS with a non-control, reserved symbol and one or more control symbols. The non-control, reserved symbol may be a repeated symbol (e.g., a first symbol and a second symbol may have the same waveform). In this case, the UE may use the first symbol to perform an AGC operation and may extract control information from the second symbol (or any subsequent symbols). Additionally, or alternatively, the network node may transmit an LP-WUS with a signal that occupies the same resource blocks as the rest of the symbols of the LP-WUS, and the UE may use the signal to perform AGC operations for the rest of the symbols of the LP-WUS. In some aspects, the UE may indicate a capability for an LP-WUS formatted to allow for AGC operation or a network node may indicate, in configuration information, that subsequent LP-WUSs are to have a format for AGC operation.

Particular aspects of the subject matter described in this disclosure can be implemented to realize one or more of the following potential advantages. In some examples, the described techniques can be used to receive an LP-WUS and decode the LP-WUS. In some examples, the described techniques can be used to perform AGC on an LP-WUS. In some examples, by enabling reception and decoding of the LP-WUS, the described techniques can be used to reduce power consumption. For example, usage of an LP-WUR for LP-WUS reception may be associated with reduced power consumption relative to single modem operation.

As described above, wireless communication systems may be deployed to provide various services, which may involve carrying or supporting voice, text, other messaging, video, data, or other traffic. Some wireless communications systems may employ multiple-access RATs. The multiple-access RATs may be capable of supporting communication with multiple wireless communication devices by sharing the available system resources (for example, time domain resources, frequency domain resources, spatial domain resources, or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies or support one or more of the foregoing use cases or new use cases.

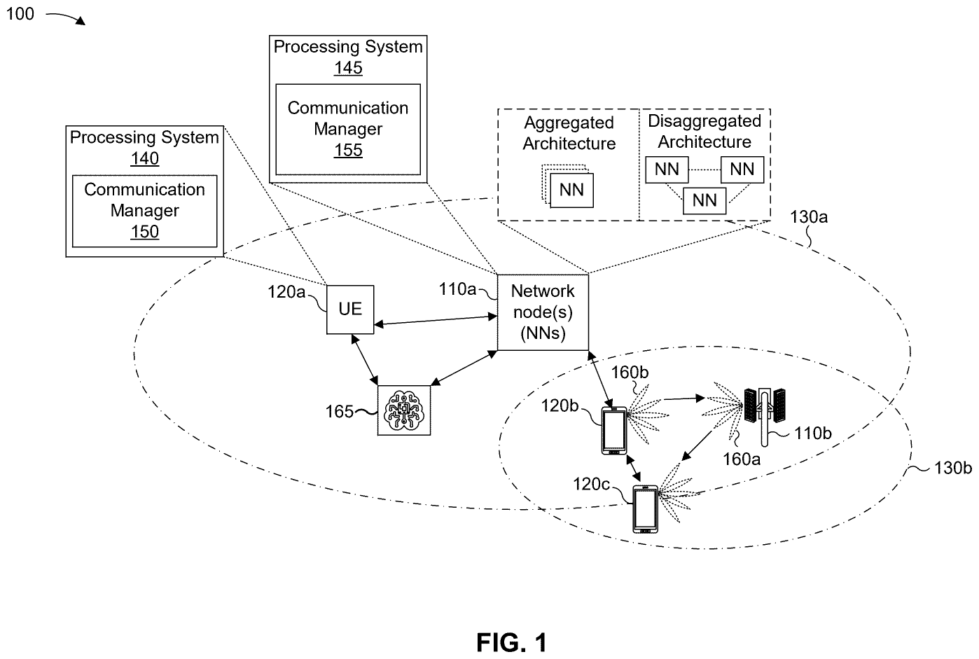

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, or that are included in mid-band frequencies. Similarly, the term “millimeter wave,” if used herein, may broadly refer to mid-band frequencies or to frequencies that are within FR2, FR4, FR4-a or FR4-1, FR5, or the EHF band. Higher frequency bands may extend 5G NR operation, 6G operation, or other RATs beyond 52.6 GHz.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 or the processing system 145 include or implement one or more of the radios, RF chains, or transceivers. An RF chain may include one or more filters, mixers, oscillators, amplifiers, ADCs, or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

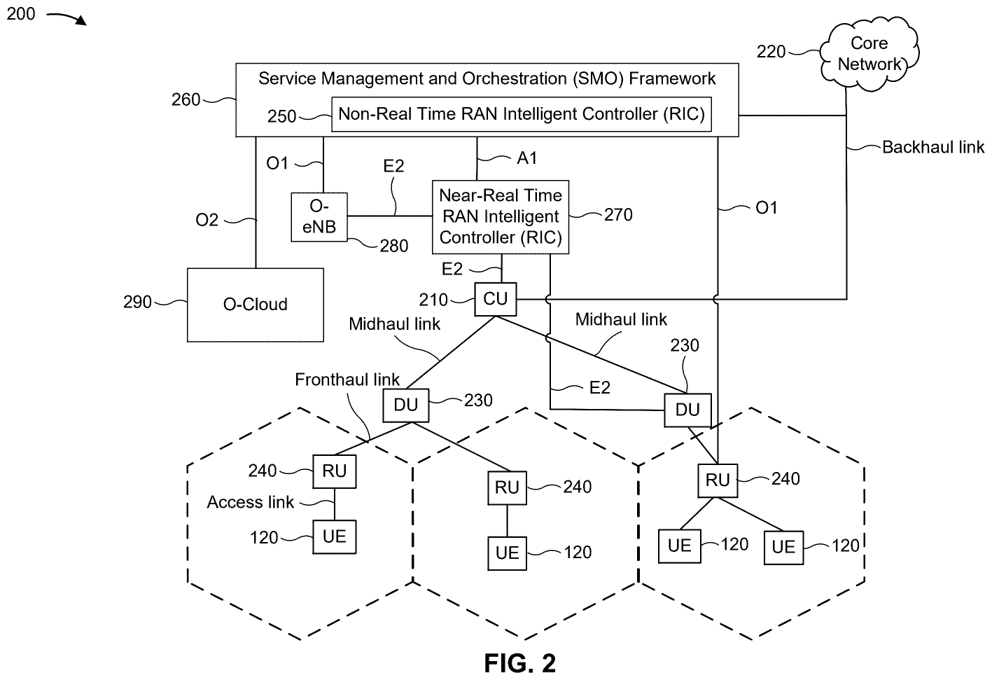

Alternatively, and as also shown, a network node 110 may be a disaggregated network node (sometimes referred to as a disaggregated base station), having a disaggregated architecture, meaning that the network node 110 may operate with a radio protocol stack that is physically distributed or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, or disaggregated network nodes, among other examples. Various different types of network nodes 110 may generally transmit at different power levels, serve different coverage areas (for example, a cell 130a and a cell 130b), or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, or any other suitable device or function that may communicate via a wireless medium.

Some UEs 120 may be classified according to different categories in association with different complexities or different capabilities. UEs 120 in a first category may facilitate massive IoT in the wireless communication network 100, and may offer low complexity or cost relative to UEs 120 in a second category. UEs 120 in a second category may include mission-critical IoT devices, legacy UEs, baseline UEs, high-tier UEs, advanced UEs, full-capability UEs, or premium UEs that are capable of URLLC, eMBB, or precise positioning in the wireless communication network 100, among other examples. A third category of UEs 120 may have mid-tier complexity or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, or an NR-Lite UE, among other examples. RedCap UEs may bridge a gap between the capability and complexity of NB-IoT devices or eMTC UEs, and mission-critical IoT devices or premium UEs. RedCap UEs may include, for example, wearable devices, IoT devices, industrial sensors, or cameras that are associated with a limited bandwidth, power capacity, or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 or UE 120 may communicate using massive MIMO, multi-user MIMO, or single-user MIMO, which may involve rapid switching between beams or cells. For example, the amplitudes or phases of signals transmitted via antenna elements or sub-elements may be modulated and shifted relative to each other (such as by manipulating a phase shift, a phase offset, or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, or a vertical direction), a set of parameters that indicate one or more aspects of a directional signal, a direction associated with the signal, or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 or at the UE 120, such as in a network implementing mmWave technology. Massive MIMO may improve communication reliability by enabling a network node 110 or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state or a quasi co-location (QCL) parameter, among other examples. The network node 110 and the UE 120 may increase reliability or achieve efficiencies in throughput, signal strength, or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, a network node 110 or UEs 120). For example, the one or more devices 165 may include a UE 120 (for example, the processing system 140), a network node 110 (for example, the processing system 145), one or more servers, or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

NES or network energy efficiency measures are expected to have increased importance in wireless network operations for various reasons, such as climate change mitigation, environmental sustainability, or network cost reduction, among other examples. For example, although NR generally offers a significant energy efficiency improvement per gigabyte over previous generations (for example, LTE), new NR use cases or the adoption of millimeter wave frequencies may require more network sites, more network antennas, larger bandwidths, or more frequency bands, among other examples which may lead to more efficient wireless networks that nonetheless have higher energy requirements or cause more emissions than previous wireless network generations. Furthermore, energy accounts for a significant proportion of the cost to operate a wireless network. For example, according to some estimates, energy costs are about one-fourth the total cost to operate a wireless network, and over 90% of network operating costs are spent on energy (for example, fuel and electricity). The largest proportion of energy consumption or energy costs are associated with a RAN, which accounts for about half of the energy consumption in a wireless network, with data centers and fiber transport accounting for smaller shares. Accordingly, measures to increase network energy savings or improve network energy efficiency are factors that may drive adoption or expansion of wireless networks.

In some examples, a UE 120 or network node 110 may implement power saving features (also referred to as energy saving features). Power saving features may include, for example, relaxed radio resource monitoring (such as relaxed reference signal monitoring for devices operating in low mobility or in good radio conditions), discontinuous reception (DRX) operation, reduced PDCCH monitoring during DRX active times, on-demand system information transmission, on-demand SSB transmission, antenna port adaptation, advanced CSI reporting, or power-efficient paging transmission and reception.

In some examples, a UE 120 may operate in association with a DRX configuration (for example, indicated to the UE 120 by a network node 110). DRX operation may enable the UE 120 to enter a sleep mode or state at various times while in the coverage area of a network node 110 to reduce power consumption for conserving battery resources, among other examples. The DRX configuration generally configures the UE 120 to operate in association with a DRX cycle. The UE 120 may repeat DRX cycles with a configured periodicity according to the DRX configuration. A DRX cycle may include a DRX on duration during which the UE 120 is in an awake mode or in an active state. A DRX cycle may also include one or more durations during which the UE 120 may operate in an inactive state. The one or more durations in which the UE 120 may operate in an inactive state may be opportunities for the UE 120 to enter a DRX sleep mode in which the UE 120 may refrain from monitoring for communications from a network node 110. Additionally or alternatively, the UE 120 may deactivate one or more antennas, RF chains, or other hardware components or devices while operating in the DRX sleep mode.

The time during which the UE 120 is configured to be in an active state during a DRX on duration may be referred to as an active time, and the time during which the UE 120 is configured to be in an inactive state, such as during a DRX sleep duration, may be referred to as an inactive time. During a DRX on duration, the UE 120 may monitor for downlink communications from one or more network nodes 110. If the UE 120 does not detect or does not successfully decode any downlink communications during the DRX on duration, the UE 120 may enter a DRX sleep mode for the inactive time duration at the end of the DRX on duration. If the UE 120 detects or successfully decodes a downlink communication during the DRX on duration, the UE 120 may remain in the active state for the duration of a DRX inactivity timer (which may extend the active time). The UE 120 may start the DRX inactivity timer at a time at which the downlink communication is received. The UE 120 may remain in the active state until the DRX inactivity timer expires, at which time the UE 120 may transition to the sleep mode for an inactive time duration. Additionally or alternatively, the UE 120 may use a DRX cycle referred to as an extended DRX (eDRX) cycle, such as for use cases that are tolerant to latency. An eDRX cycle may include a relatively longer inactive time relative to a baseline DRX cycle (for example, an eDRX cycle may have a lower ratio of active time to inactive time).

As described above, a UE 120 may achieve additional power savings in connection with a DRX mode by using an LP-WUR to monitor for an LP-WUS. For example, the LP-WUR may use reduced power resources relative to a main radio, so a UE 120 may achieve power savings by using the LP-WUR to monitor for a wake-up signal that triggers a transition to an active mode (and use of the main radio) relative to using the main radio to monitor for a signal that triggers a transition to an active mode. An LP-WUR may be used, by a UE 120, in connection with a DRX mode or separate from a DRX mode (e.g., to reduce power consumption associated with other monitoring procedures). The UE 120 may receive a first type of signal on the LP-WUR and a second type of signal on the main radio. For example, the network node 110 may transmit, and the UE 120 may receive, an OOK modulated signal on the LP-WUR and a non-OOK modulated signal (e.g., another modulation type, such as QAM or phase shift keying (PSK)) on the main radio.

In some aspects, the UE 120 may include a communication manager 150. As described in more detail elsewhere herein, the communication manager 150 may receive, using an LP-WUR, an LP-WUS in a set of symbols, wherein the set of symbols includes a first subset of the set of symbols and a second subset of the set of symbols occurring after the first subset of the set of symbols, wherein control information is conveyed starting at the second subset of the set of symbols; and communicate, using a main radio, in accordance with the LP-WUS. Additionally, or alternatively, the communication manager 150 may perform one or more other operations described herein.

In some aspects, the network node 110 may include a communication manager 155. As described in more detail elsewhere herein, the communication manager 155 may transmit a LP-WUS in a set of symbols, wherein the set of symbols includes a first subset of the set of symbols and a second subset of the set of symbols occurring after the first subset of the set of symbols, wherein control information is conveyed starting at the second subset of the set of symbols, wherein the LP-WUS is a first type of modulation signal for reception by a first type of radio; and communicate, using a second type of modulation signal for reception by a second type of radio, in accordance with the LP-WUS. Additionally, or alternatively, the communication manager 155 may perform one or more other operations described herein.

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

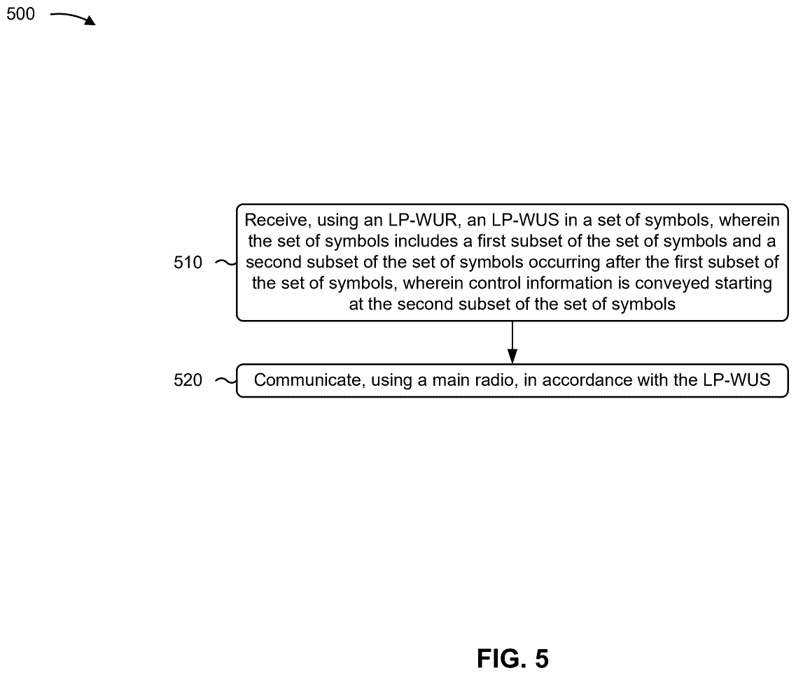

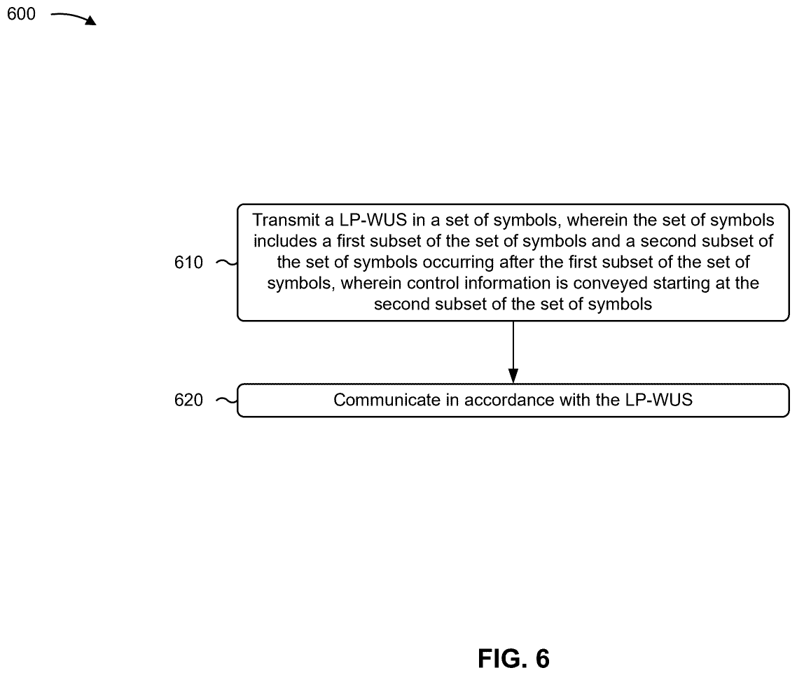

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with using an LP-WUS with AGC information, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, or other processes as described herein. In some examples, executing instructions may include running the instructions, converting the instructions, compiling the instructions, or interpreting the instructions, among other examples.

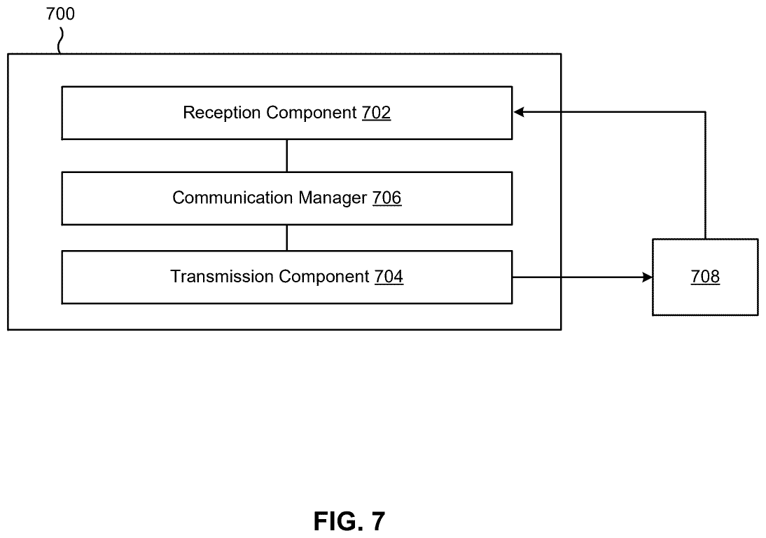

In some aspects, the UE 120 includes means for receiving, using an LP-WUR, an LP-WUS in a set of symbols, wherein the set of symbols includes a first subset of the set of symbols and a second subset of the set of symbols occurring after the first subset of the set of symbols, wherein control information is conveyed starting at the second subset of the set of symbols; or means for communicating, using a main radio, in accordance with the LP-WUS. The means for the UE 120 to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

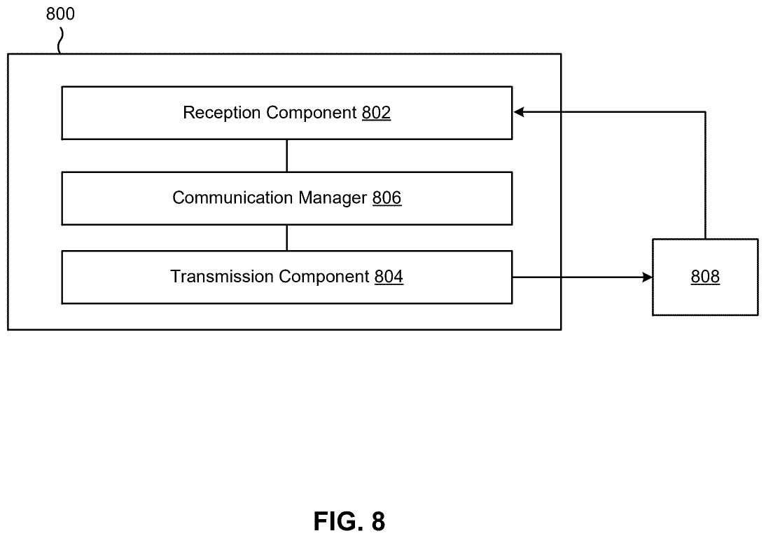

In some aspects, the network node 110 includes means for transmitting an LP-WUS in a set of symbols, wherein the set of symbols includes a first subset of the set of symbols and a second subset of the set of symbols occurring after the first subset of the set of symbols, wherein control information is conveyed starting at the second subset of the set of symbols, wherein the LP-WUS is a first type of modulation signal for reception by a first type of radio; or means for communicating, using a second type of modulation signal for reception by a second type of radio, in accordance with the LP-WUS. The means for the network node 110 to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

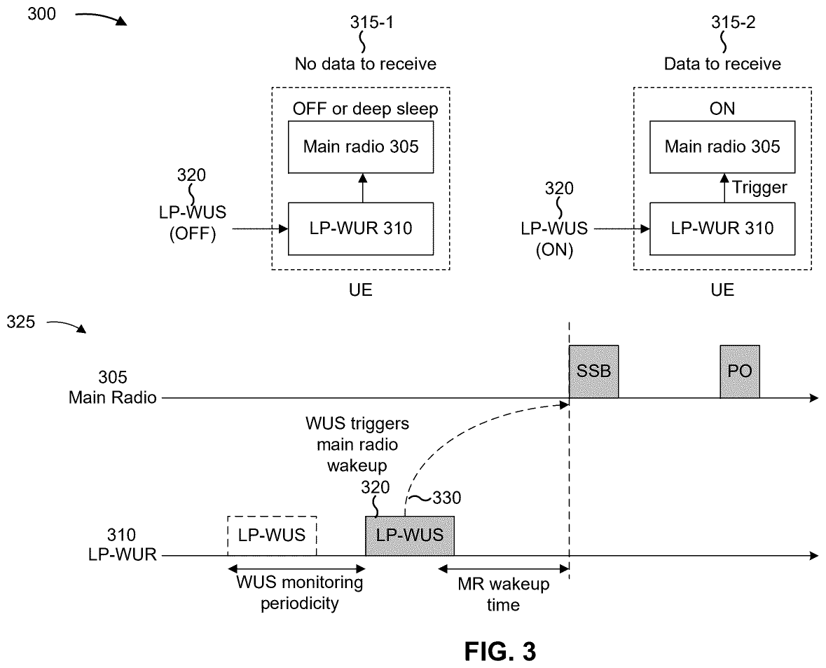

FIG. 3 is a diagram illustrating an example 300 of an LP-WUR and an LP-WUS. As shown in FIG. 3, a UE (such as UE 120) may be equipped with a communication system that includes a main radio (illustrated as “MR”) 305 and an LP-WUR 310 to reduce power consumption and enable low latency. For example, power saving and low latency are often conflicting goals because placing one or more components into a sleep state more often to reduce power consumption also increases latency (e.g., because data cannot be transmitted or received while the one or more components are in the sleep state), and because reducing the time that one or more components spend in a sleep state to reduce latency can lead to increased power consumption. Accordingly, as shown in FIG. 3, the UE may be equipped with the LP-WUR 310, which may be considered a companion receiver that can be used with a main radio 305 to reduce power consumption and latency.

For example, in some aspects, the UE may generally use the main radio 305 to transmit or receive user data, and the main radio 305 may be turned off or operated in a deep sleep state unless there is user data to transmit or receive. Furthermore, the LP-WUR 310 may serve as a simple wakeup receiver for the main radio 305, and the LP-WUR 310 may be active and monitoring for an LP-WUS while the main radio 305 is off or in the deep sleep state. For example, reference number 315-1 depicts a first state associated with the main radio 305 and the LP-WUR 310 where there is no user data to be provided to the main radio 305. In such cases, the main radio 305 may be off or operated in the deep sleep state unless there is user data to transmit, and the LP-WUR 310 may monitor for an LP-WUS (for example, continuously, or periodically in monitoring occasions that are separated in time). Furthermore, reference number 315-2 depicts a second state associated with the main radio 305 and the LP-WUR 310 where there is user data for the main radio 305. In such cases, the LP-WUR 310 may receive an LP-WUS 320 (such as from a network node 110) and may provide a trigger to wake or otherwise activate the main radio 305 based on detecting the LP-WUS 320. Accordingly, the main radio 305 may then transmit or receive user data.

In general, the LP-WUR 310 may consume very little power (for example a target power consumption less than 100 microwatts (μW) in the active state), which may be achieved using simple modulation schemes (for example, OOK), a narrow bandwidth (for example, less than 5 MHz), or other suitable techniques. In this way, the LP-WUR 310 can be used to reduce the time that the main radio 305 spends in an on state or may avoid unnecessarily waking the main radio 305 from the off or deep sleep state when there is no user data to transmit or receive, which tends to be costly from a power consumption perspective. Furthermore, because the LP-WUR 310 has a very low power consumption, the LP-WUR 310 can be used to frequently or continuously perform LP-WUS monitoring, which may improve latency because the main radio 305 can be woken up when there is user data that the main radio 305 needs to receive. For example, the LP-WUR 310 may not suffer from the latency versus power efficiency tradeoff associated with duty cycling schemes, such as DRX. Furthermore, in addition to performing LP-WUS monitoring, which may be used for paging reception, the LP-WUR 310 may monitor a low power synchronization signal (LP-SS) for time and frequency tracking and radio resource management (RRM) measurement. In this way, by monitoring the LP-SS, serving cell or neighbor cell monitoring can be offloaded from the main radio 305 to the LP-WUR 310 to reduce how often the main radio 305 is woken up, which can further reduce power consumption.

In some aspects, the LP-WUR 310 may include an OOK WUR (also referred to as an envelope detector (ED) WUR). An OOK WUR may only detect the amplitude (such as the magnitude) of a received signal. A UE that uses an OOK WUR may detect the phase of a received signal by activating the main radio 305.

In some aspects, the LP-WUR 310 may include an OFDM WUR (which may be referred to as an in-phase and quadrature (IQ) WUR). An OFDM WUR can detect both the amplitude and phase of a received signal. For example, an OFDM WUR can obtain first information that is modulated onto a signal using OOK modulation, and second information that is modulated onto the signal using phase modulation.

In some aspects, as shown by reference number 325, one application of the LP-WUR 310 is to monitor the LP-WUS 320 for paging monitoring, which can be used to reduce unnecessary paging reception performed by the main radio 305. For example, as shown in FIG. 3, the LP-WUR 310 may be configured to monitor for an LP-WUS 320 (while the main radio 305 is off or in a deep sleep state) according to a WUS monitoring periodicity. For example, the LP-WUR 310 may monitor for the LP-WUS 320 in periodic LP-WUS monitoring occasions that are spaced in time according to the WUS monitoring periodicity. Alternatively, although not explicitly shown in FIG. 3, the LP-WUR 310 may be configured to continuously monitor for the LP-WUS 320. In general, a network node may transmit an LP-WUS 320 to a UE only in cases where there is a paging message that needs to be sent to the UE while the UE is in an idle or inactive state (such as an RRC idle or RRC inactive state). In such cases, as shown by reference number 330, the LP-WUR 310 may receive and detect the LP-WUS 320, which may trigger the LP-WUR 310 to wake up the main radio 305. In some aspects, the LP-WUS 320 may be a sequence-based WUS, which may include a predefined set of sequences (implemented, for example, using OOK modulation or phase modulation). As shown, the main radio 305 may wake up after a main radio wakeup time, and may then start to monitor one or more SSB transmissions to obtain synchronization with the network node before monitoring and receiving the paging message in a subsequent paging opportunity. Otherwise, in cases where the LP-WUR 310 does not detect the LP-WUS 320, the main radio 305 may remain in the deep sleep state to save power.

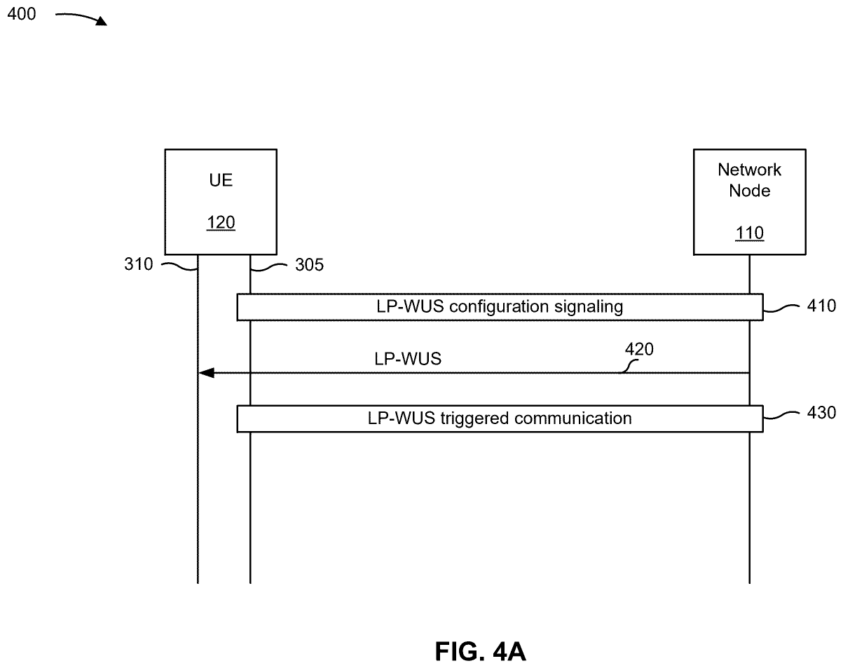

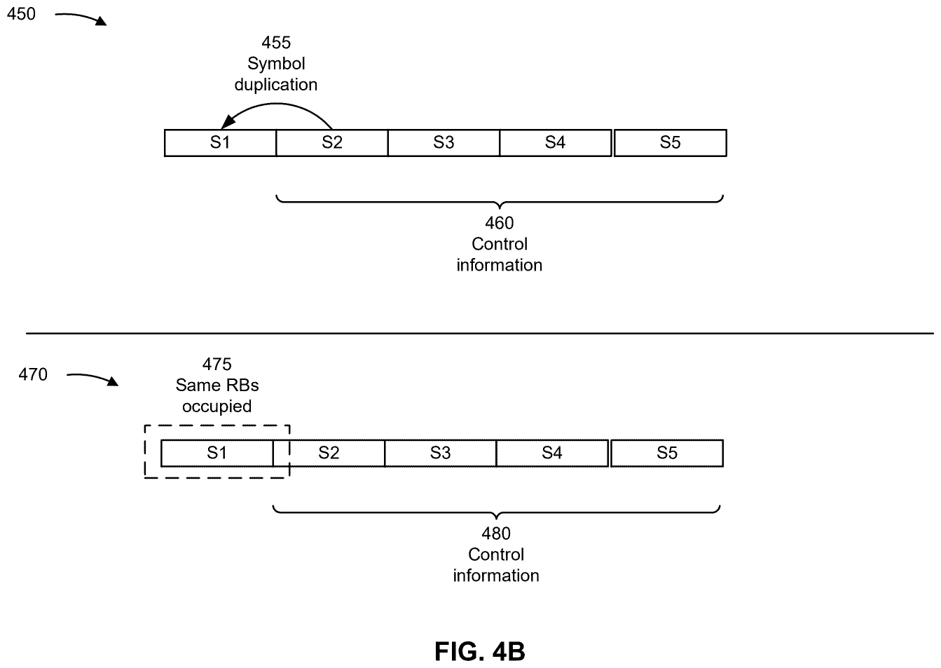

FIGS. 4A and 4B are diagrams illustrating an example 400 associated with LP-WUS indication with AGC information. As shown in FIG. 4A, example 400 includes communication between a network node 110 and a UE 120.

As further shown in FIG. 4A, and by reference number 410, a UE 120 and a network node 110 may communicate to configure LP-WUS signaling. For example, a UE 120 or a network node 110 may transmit or receive LP-WUS configuration signaling. In some aspects, the UE 120 may transmit, on a main radio 305, a UE capability indicator associated with indicating an AGC capability. For example, the UE 120 may transmit the UE capability indicator (e.g., when configuring PDCCH monitoring) with a parameter value that the network node 110 may interpret as triggering symbol repetition, among other examples, in an LP-WUS as described in more detail herein. In this case, the network node 110 may transmit an LP-WUS with a format that is based on the UE capability indicator. For example, the network node 110 may transmit an LP-WUS with a repeated symbol (e.g., which the UE 120 may use for AGC operations) based on receiving the UE capability indicator. Additionally, or alternatively, the network node 110 may transmit, and the UE 120 may receive on the main radio 305, LP-WUS configuration signaling indicating a format of a subsequent LP-WUS. For example, the network node 110 may indicate that a subsequent LP-WUS is a format with a repeated symbol (e.g., which the UE 120 may use for AGC operations), among other examples, as described in more detail herein.

In some aspects, the network node 110 or UE 120 may transmit an explicit indicator of a format of the LP-WUS. For example, the UE 120 may transmit a UE capability indicator or the network node 110 may transmit a configuration indication with a field that indicates whether the LP-WUS is formatted with a format that enables AGC operation. Additionally, or alternatively, the network node 110 or the UE 120 may transmit an implicit indicator of the format of the LP-WUS. For example, when the network node 110 transmits a configuration indication indicating that the LP-WUS is configured for a first quantity of symbols, the UE 120 may determine that the format of the LP-WUS is configured for AGC operation (e.g., with symbol duplication, as described herein). Alternatively, when the network node 110 transmits a configuration indication indicating that the LP-WUS is configured for a second quantity of symbols, the UE 120 may determine that the LP-WUS is not configured for AGC operation.

As further shown in FIG. 4A, and by reference number 420, the network node 110 may transmit, and the UE 120 may receive using the LP-WUR 310, an LP-WUS. For example, the network node 110 may transmit an LP-WUS with a format that includes information that the UE 120 may use for AGC operations. In some aspects, the network node 110 may transmit, and the UE 120 may receive, an LP-WUS with a format that includes a plurality of communication resources. For example, the UE 120 may receive an LP-WUS that occupies a plurality of consecutive symbols (e.g., consecutive with respect to a time domain). The plurality of consecutive symbols may correspond to a resource allocation for the LP-WUS. In some aspects, the LP-WUS may include a first subset of symbols of the LP-WUS that is used for one or more non-control symbols, such as for gain control. In some aspects, a first symbol of the LP-WUS may include a resource allocation for the LP-WUS and a second symbol of the LP-WUS may include a resource allocation for control information. After the first subset of symbols used for one or more non-control symbols, a second subset of symbols may be used for one or more control symbols.

As shown in the FIG. 4B, and by diagram 450, the UE 120 may receive a set of 5 symbols S1 through S5. In the illustrated example, the first subset of symbols includes only one symbol, but it is understood that the first subset of symbols may, in other examples, include more than one symbol. For example, the UE 120 may receive the set of 5 symbols in a resource allocation for LP-WUS signaling. In some aspects, the set of symbols of the LP-WUS may include a duplicated symbol. For example, the network node 110 may transmit the LP-WUS with a format that includes the symbol S2 duplicated in the symbol S1, as shown by reference number 455. In this case, the symbols S1 and S2 may be a pair of instances of the same signal waveform. Accordingly, when the UE 120 receives a first subset of a set of symbols (e.g., S1 of the set of symbols S1 through S5), the UE 120 may determine an average power of the first subset of the set of symbols (e.g., an average power across S1). Based on determining the average power, the UE 120 may set an AGC gain for receiving a second subset of the set of symbols (e.g., S2 through S5 of the set of symbols S1 through S5). In other words, the first subset of symbols (e.g., S1) may be a resource allocation of one or more symbols for non-control information and the second subset of symbols (e.g., S2 through S5) may be a resource allocation for one or more symbols for control information. In this case, the network node 110 may convey control information in the second subset of the set of symbols (e.g., S2 through S5), as shown by reference number 460, rather than in the first subset of the set of symbols (e.g., which is transmitted to provide for AGC operation). In other words, in a resource allocation for LP-WUS signaling, there may be a first symbol that is a non-control symbol reserved for gain control (e.g., a repetition of a second symbol) and a second through nth symbol that are control symbols (e.g., conveying information of the LP-WUS to the UE 120).

The control information conveyed in the second subset of the set of symbols may include a UE identifier of the UE 120 or a UE group identifier of a UE group with which the UE 120 is associated, among other examples. Additionally, or alternatively, the control information may include an indication to monitor for a PDCCH communication, such as to receive, via the PDCCH communication, further control signaling from the network node 110. In some aspects, the network node 110 may transmit a set of symbols with a common set of RBs that can be used by the UE 120 for AGC operation. For example, as shown by diagram 470 and reference number 475, the UE 120 may receive a first symbol S1 that includes a signal occupying a same set of RBs as is used for other symbols S2 through S5 in a LP-WUS. In other words, a network node 110 may allocate a set of N consecutive symbols and the UE 120 may extract a control signal starting from a second symbol, as shown by reference number 480. In this case, the first symbol S1 may not include a control signal, and the UE 120 may use the first symbol for AGC operation.

Although some aspects are described herein in terms of one symbol being used for AGC operation, it is understood that another quantity of symbols may be used for AGC operation. For example, the UE 120 may receive a first subset of K symbols that the UE 120 may use for AGC operation and a second subset of J symbols from which the UE 120 may extract control information (e.g., information indicating that the UE 120 is to wake up a main radio or communicate in a set of resources, among other examples). In this case, the network node 110 may configure the UE 120 with information indicating a quantity of symbols in the first subset K or the second subset J. For example, when the network node 110 configures LP-WUS and PDCCH monitoring, the network node 110 may include an explicit indicator in a configuration information message to identify a quantity of AGC symbols or other AGC resources. Additionally, or alternatively, the network node 110 may implicitly indicate the quantity of AGC symbols by indicating a quantity of symbols of the LP-WUS message (e.g., when an LP-WUS message uses 5 symbols for control information and is configured for 8 symbols, the UE 120 may derive that 3 symbols are allocated for AGC operation).

As further shown in FIG. 4A, and by reference number 430, the UE 120 and the network node 110 may communicate in accordance with the LP-WUS. For example, based on receiving and decoding the LP-WUS on the LP-WUR 310, the UE 120 may be triggered to activate the main radio 305 for PDCCH monitoring. In this case, the UE 120 may receive a PDCCH communication on the main radio 305, which may trigger or schedule subsequent uplink or downlink communication. Additionally, or alternatively, the UE 120 may be triggered to perform another communication operation responsive to receiving the LP-WUS. For example, the UE 120 may transmit on an uplink based on receiving an LP-WUS, receive another type of signaling on a downlink based on receiving the LP-WUS, or communicate on another type of link (e.g., a sidelink or relay link) based on receiving the LP-WUS, among other examples.

As indicated above, FIGS. 4A and 4B are provided as an example. Other examples may differ from what is described with respect to FIGS. 4A and 4B.

FIG. 5 is a diagram illustrating an example process 500 performed, for example, at a UE or an apparatus of a UE. Example process 500 is an example where the apparatus or the UE (e.g., UE 120) performs operations associated with an LP-WUS with AGC information.

As shown in FIG. 5, in some aspects, process 500 may include receiving, using an LP-WUR, an LP-WUS in a set of symbols, wherein the set of symbols includes a first subset of the set of symbols and a second subset of the set of symbols occurring after the first subset of the set of symbols, wherein control information is conveyed starting at the second subset of the set of symbols (block 510). For example, the UE (e.g., using reception component 702 or communication manager 706, depicted in FIG. 7) may receive, using an LP-WUR, an LP-WUS in a set of symbols, wherein the set of symbols includes a first subset of the set of symbols and a second subset of the set of symbols occurring after the first subset of the set of symbols, wherein control information is conveyed starting at the second subset of the set of symbols, as described above.

As further shown in FIG. 5, in some aspects, process 500 may include communicating, using a main radio, in accordance with the LP-WUS (block 520). For example, the UE (e.g., using reception component 702, transmission component 704, or communication manager 706, depicted in FIG. 7) may communicate, using a main radio, in accordance with the LP-WUS, as described above.

Process 500 may include additional aspects, such as any single aspect or any combination of aspects described below or in connection with one or more other processes described elsewhere herein.

In a first aspect, a first waveform of at least one first symbol, of the first subset of the set of symbols, and a second waveform of at least one second symbol, of the second subset of the set of symbols, are the same waveform.

In a second aspect, alone or in combination with the first aspect, process 500 includes setting an automatic gain control parameter for the second subset of the set of symbols based at least in part on a measurement of the first subset of the set of symbols.

In a third aspect, alone or in combination with one or more of the first and second aspects, process 500 includes transmitting information indicative of a UE capability, and wherein the information indicative of the UE capability enables control information to be conveyed starting from the second subset of the set of symbols.

In a fourth aspect, alone or in combination with one or more of the first through third aspects, the UE capability includes an indication of a quantity of symbols in the first subset of the set of symbols.

In a fifth aspect, alone or in combination with one or more of the first through fourth aspects, process 500 includes receiving information indicative of a gain control setting, and wherein the control information is conveyed starting from the second subset of the set of symbols in accordance with the gain control setting.

In a sixth aspect, alone or in combination with one or more of the first through fifth aspects, the gain control setting is associated with at least one of a quantity of symbols of the set of symbols, or a parameter value indicating that the control information is conveyed starting from the second subset of the set of symbols, or both.

In a seventh aspect, alone or in combination with one or more of the first through sixth aspects, the first subset of the set of symbols includes a first instance of a signal that is conveyed in a set of resource blocks of the first subset of the set of symbols, and wherein the second subset of the set of symbols includes a second instance of the signal that is conveyed in the set of resource blocks of the second subset of the set of symbols.

In an eighth aspect, alone or in combination with one or more of the first through seventh aspects, the LP-WUS is allocated in a configured quantity of consecutive symbols, such that the control information is extractable starting from the second subset of the set of symbols.

In a ninth aspect, alone or in combination with one or more of the first through eighth aspects, the first symbol, of the set of symbols, is a non-control symbol.

In a tenth aspect, alone or in combination with one or more of the first through ninth aspects, the non-control symbol is reserved for gain control.

In an eleventh aspect, alone or in combination with one or more of the first through tenth aspects, a resource allocation for the LP-WUS starts at a first symbol and a resource allocation for the control information of the LP-WUS starts at a second symbol occurring after the first symbol.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node. Example process 600 is an example where the apparatus or the network node (e.g., network node 110) performs operations associated with an LP-WUS with AGC information.

As shown in FIG. 6, in some aspects, process 600 may include transmitting an LP-WUS in a set of symbols, wherein the set of symbols includes a first subset of the set of symbols and a second subset of the set of symbols occurring after the first subset of the set of symbols, wherein control information is conveyed starting at the second subset of the set of symbols (block 610). For example, the network node (e.g., using transmission component 804 or communication manager 806, depicted in FIG. 8) may transmit an LP-WUS in a set of symbols, wherein the set of symbols includes a first subset of the set of symbols and a second subset of the set of symbols occurring after the first subset of the set of symbols, wherein control information is conveyed starting at the second subset of the set of symbols, as described above. In some aspects, the LP-WUS is a first type of modulation signal for reception by a first type of radio.

As further shown in FIG. 6, in some aspects, process 600 may include communicating in accordance with the LP-WUS (block 620). For example, the network node (e.g., using reception component 802, transmission component 804, or communication manager 806, depicted in FIG. 8) may communicate in accordance with the LP-WUS, as described above. In some aspects, the communication may be associated with a second type of modulation signal that is for reception by a second type of radio.

Process 600 may include additional aspects, such as any single aspect or any combination of aspects described below or in connection with one or more other processes described elsewhere herein.

In a first aspect, the first type of modulation signal is an OOK modulated signal for reception by an LP-WUR.

In a second aspect, alone or in combination with the first aspect, the second type of modulation signal is a non-OOK modulated signal for reception by a main radio.

In a third aspect, alone or in combination with one or more of the first and second aspects, a first waveform of at least one first symbol, of the first subset of the set of symbols, and a second waveform of at least one second symbol, of the second subset of the set of symbols, are the same waveform.

In a fourth aspect, alone or in combination with one or more of the first through third aspects, an automatic gain control parameter for the second subset of the set of symbols is based at least in part on the first subset of the set of symbols.

In a fifth aspect, alone or in combination with one or more of the first through fourth aspects, process 600 includes receiving information indicative of a UE capability, and wherein the information indicative of the UE capability enables control information to be conveyed starting from the second subset of the set of symbols.

In a sixth aspect, alone or in combination with one or more of the first through fifth aspects, the UE capability includes an indication of a quantity of symbols in the first subset of the set of symbols.

In a seventh aspect, alone or in combination with one or more of the first through sixth aspects, process 600 includes transmitting information indicative of a gain control setting, and wherein the control information is conveyed starting from the second subset of the set of symbols in accordance with the gain control setting.

In an eighth aspect, alone or in combination with one or more of the first through seventh aspects, the gain control setting is associated with at least one of a quantity of symbols of the set of symbols, or a parameter value indicating that the control information is conveyed starting from the second subset of the set of symbols, or both.

In a ninth aspect, alone or in combination with one or more of the first through eighth aspects, the first subset of the set of symbols includes a first instance of a signal that is conveyed in a set of resource blocks of the first subset of the set of symbols, and wherein the second subset of the set of symbols includes a second instance of the signal that is conveyed in the set of resource blocks of the second subset of the set of symbols.

In a tenth aspect, alone or in combination with one or more of the first through ninth aspects, the LP-WUS is allocated in a configured quantity of consecutive symbols, such that the control information is extractable starting from the second subset of the set of symbols.

In an eleventh aspect, alone or in combination with one or more of the first through tenth aspects, the first symbol, of the set of symbols, is a non-control symbol.

In a twelfth aspect, alone or in combination with one or more of the first through eleventh aspects, the non-control symbol is reserved for gain control.

In an thirteenth aspect, alone or in combination with one or more of the first through twelfth aspects, a resource allocation for the LP-WUS starts at a first symbol and a resource allocation for control information of the LP-WUS starts at a second symbol occurring after the first symbol.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIGS. 4A-4B. Additionally, or alternatively, the apparatus 700 may be configured to perform one or more processes described herein, such as process 500 of FIG. 5. In some aspects, the apparatus 700 or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The reception component 702 may receive, using an LP-WUR, an LP-WUS in a set of symbols, wherein the set of symbols includes a first subset of the set of symbols and a second subset of the set of symbols occurring after the first subset of the set of symbols, wherein control information is conveyed starting at the second subset of the set of symbols. The reception component 702 or the transmission component 704 may communicate, using a main radio, in accordance with the LP-WUS.

The communication manager 706 may set an automatic gain control parameter for the second subset of the set of symbols based at least in part on a measurement of the first subset of the set of symbols. The transmission component 704 may transmit information indicative of a UE capability, and wherein the information indicative of the UE capability enables control information to be conveyed starting from the second subset of the set of symbols. The reception component 702 may receive information indicative of a gain control setting, and wherein the control information is conveyed starting from the second subset of the set of symbols in accordance with the gain control setting.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a network node, or a network node may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIGS. 4A-4B. Additionally, or alternatively, the apparatus 800 may be configured to perform one or more processes described herein, such as process 600 of FIG. 6. In some aspects, the apparatus 800 or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 or the transmission component 804 may include or may be included in a network interface. The network interface may be configured to obtain or output signals for the apparatus 800 via one or more communications links, such as a backhaul link, a midhaul link, or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The transmission component 804 may transmit an LP-WUS in a set of symbols, wherein the set of symbols includes a first subset of the set of symbols and a second subset of the set of symbols occurring after the first subset of the set of symbols, wherein control information is conveyed starting at the second subset of the set of symbols, wherein the LP-WUS is a first type of modulation signal for reception by a first type of radio. The reception component 802 or the transmission component 804 may communicate, using a second type of modulation signal for reception by a second type of radio, in accordance with the LP-WUS.

The reception component 802 may receive information indicative of a UE capability, and wherein the information indicative of the UE capability enables control information to be conveyed starting from the second subset of the set of symbols. The transmission component 804 may transmit information indicative of a gain control setting, and wherein the control information is conveyed starting from the second subset of the set of symbols in accordance with the gain control setting.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: receiving, using a low-power wake-up radio (LP-WUR), a low-power wake-up signal (LP-WUS) in a set of symbols, wherein the set of symbols includes a first subset of the set of symbols and a second subset of the set of symbols occurring after the first subset of the set of symbols, wherein control information is conveyed starting at the second subset of the set of symbols; and communicating, using a main radio, in accordance with the LP-WUS.

Aspect 2: The method of Aspect 1, wherein a first waveform of at least one first symbol, of the first subset of the set of symbols, and a second waveform of at least one second symbol, of the second subset of the set of symbols, are the same waveform.

Aspect 3: The method of any of Aspects 1-2, further comprising: setting an automatic gain control parameter for the second subset of the set of symbols based at least in part on a measurement of the first subset of the set of symbols.

Aspect 4: The method of any of Aspects 1-3, further comprising: transmitting information indicative of a UE capability, and wherein the information indicative of the UE capability enables control information to be conveyed starting from the second subset of the set of symbols.

Aspect 5: The method of Aspect 4, wherein the UE capability includes an indication of a quantity of symbols in the first subset of the set of symbols.

Aspect 6: The method of any of Aspects 1-5, further comprising: receiving information indicative of a gain control setting, and wherein the control information is conveyed starting from the second subset of the set of symbols in accordance with the gain control setting.

Aspect 7: The method of Aspect 6, wherein the gain control setting is associated with at least one of: a quantity of symbols of the set of symbols, or a parameter value indicating that the control information is conveyed starting from the second subset of the set of symbols, or both.

Aspect 8: The method of any of Aspects 1-7, wherein the first subset of the set of symbols includes a first instance of a signal that is conveyed in a set of resource blocks of the first subset of the set of symbols, and wherein the second subset of the set of symbols includes a second instance of the signal that is conveyed in the set of resource blocks of the second subset of the set of symbols.

Aspect 9: The method of any of Aspects 1-8, wherein the LP-WUS is allocated in a configured quantity of consecutive symbols, such that the control information is extractable starting from the second subset of the set of symbols.

Aspect 10: The method of any of Aspects 1-9, wherein the first subset of symbols, of the set of symbols, comprises one or more non-control symbols.

Aspect 11: The method of any of Aspects 1-10, wherein the one or more non-control symbol are reserved for gain control.

Aspect 12: The method of any of Aspects 1-11, wherein a resource allocation for the LP-WUS starts at a first symbol and a resource allocation for control information of the LP-WUS starts at a second symbol occurring after the first symbol.

Aspect 13: A method of wireless communication performed by a network node, comprising: transmitting a low-power wake-up signal (LP-WUS) in a set of symbols, wherein the set of symbols includes a first subset of the set of symbols and a second subset of the set of symbols occurring after the first subset of the set of symbols, wherein control information is conveyed starting at the second subset of the set of symbols, wherein the LP-WUS is a first type of modulation signal for reception by a first type of radio; and communicating, using a second type of modulation signal for reception by a second type of radio, in accordance with the LP-WUS.

Aspect 14: The method of Aspect 13, wherein the first type of modulation signal is an on-off keying (OOK) modulated signal for reception by a low-power wake-up radio (LP-WUR).

Aspect 15: The method of any of Aspects 13-14, wherein the second type of modulation signal is a non on-off keying (non-OOK) modulated signal for reception by a main radio.

Aspect 16: The method of any of Aspects 13-15, wherein a first waveform of at least one first symbol, of the first subset of the set of symbols, and a second waveform of at least one second symbol, of the second subset of the set of symbols, are the same waveform.

Aspect 17: The method of any of Aspects 13-16, wherein an automatic gain control parameter for the second subset of the set of symbols is based at least in part on the first subset of the set of symbols.

Aspect 18: The method of any of Aspects 13-17, further comprising: receiving information indicative of a user equipment (UE) capability, and wherein the information indicative of the UE capability enables control information to be conveyed starting from the second subset of the set of symbols.

Aspect 19: The method of Aspect 18, wherein the UE capability includes an indication of a quantity of symbols in the first subset of the set of symbols.

Aspect 20: The method of any of Aspects 13-19, further comprising: transmitting information indicative of a gain control setting, and wherein the control information is conveyed starting from the second subset of the set of symbols in accordance with the gain control setting.

Aspect 21: The method of Aspect 20, wherein the gain control setting includes information indicative of at least one of: a quantity of symbols of the set of symbols, or a parameter value indicating that the control information is conveyed starting from the second subset of the set of symbols, or both.

Aspect 22: The method of any of Aspects 13-21, wherein the first subset of the set of symbols includes a first instance of a signal that is conveyed in a set of resource blocks of the first subset of the set of symbols, and wherein the second subset of the set of symbols includes a second instance of the signal that is conveyed in the set of resource blocks of the second subset of the set of symbols.

Aspect 23: The method of any of Aspects 13-22, wherein the LP-WUS is allocated in a configured quantity of consecutive symbols, such that the control information is extractable starting from the second subset of the set of symbols.

Aspect 24: The method of any of Aspects 13-23, wherein the first subset of symbols, of the set of symbols, comprises one or more non-control symbols.

Aspect 25: The method of any of Aspects 13-24, wherein the one or more non-control symbols are reserved for gain control.

Aspect 26: The method of any of Aspects 13-25, wherein a resource allocation for the LP-WUS starts at a first symbol and a resource allocation for control information of the LP-WUS starts at a second symbol occurring after the first symbol.

Aspect 27: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-26.

Aspect 28: An apparatus for wireless communication at a device, the apparatus comprising one or more memories and one or more processors coupled to the one or more memories, the one or more processors configured to cause the device to perform the method of one or more of Aspects 1-26.

Aspect 29: An apparatus for wireless communication, the apparatus comprising at least one means for performing the method of one or more of Aspects 1-26.

Aspect 30: A non-transitory computer-readable medium storing code for wireless communication, the code comprising instructions executable by one or more processors to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

Aspect 32: A device for wireless communication, the device comprising a processing system that includes one or more processors and one or more memories coupled with the one or more processors, the processing system configured to cause the device to perform the method of one or more of Aspects 1-26.

Aspect 33: An apparatus for wireless communication at a device, the apparatus comprising one or more memories and one or more processors coupled to the one or more memories, the one or more processors individually or collectively configured to cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, using a low-power wake-up radio (LP-WUR), a low-power wake-up signal (LP-WUS) in a set of symbols, wherein the set of symbols includes a first subset of the set of symbols and a second subset of the set of symbols occurring after the first subset of the set of symbols, wherein control information is conveyed starting at the second subset of the set of symbols; and
communicate, using a main radio, in accordance with the LP-WUS.

2. The UE of claim 1, wherein the first subset of the set of symbols comprises one or more non-control symbols.

3. The UE of claim 2, wherein the one or more non-control symbols are reserved for gain control.

4. The UE of claim 1, wherein a resource allocation for the LP-WUS starts at a first symbol and a resource allocation for control information of the LP-WUS starts at a second symbol occurring after the first symbol.

5. The UE of claim 1, wherein a first waveform of at least one first symbol, of the first subset of the set of symbols, and a second waveform of at least one second symbol, of the second subset of the set of symbols, are the same waveform.

6. The UE of claim 1, wherein the one or more processors are further configured to cause the UE to:
set an automatic gain control parameter for the second subset of the set of symbols based at least in part on a measurement of the first subset of the set of symbols.

7. The UE of claim 1, wherein the one or more processors are further configured to cause the UE to:
transmit information indicative of a UE capability, and wherein the information indicative of the UE capability enables control information to be conveyed starting from the second subset of the set of symbols.

8. The UE of claim 7, wherein the UE capability includes information indicative of a quantity of symbols in the first subset of the set of symbols.

9. The UE of claim 1, wherein the one or more processors are further configured to cause the UE to:
receive information indicative of a gain control setting, and wherein the control information is conveyed starting from the second subset of the set of symbols in accordance with the gain control setting.

10. The UE of claim 9, wherein the gain control setting is associated with at least one of:
a quantity of symbols of the set of symbols, or
a parameter value indicating that the control information is conveyed starting from the second subset of the set of symbols, or
both.

11. The UE of claim 1, wherein the first subset of the set of symbols includes a first instance of a signal that is conveyed in a set of resource blocks of the first subset of the set of symbols, and wherein the second subset of the set of symbols includes a second instance of the signal that is conveyed in the set of resource blocks of the second subset of the set of symbols.

12. The UE of claim 1, wherein the LP-WUS is allocated in a configured quantity of consecutive symbols, such that the control information is extractable starting from the second subset of the set of symbols.

13. A network node for wireless communication, comprising:
one or more memories; and
one or more processors, coupled to the one or more memories, configured to cause the network node to:
transmit a low-power wake-up signal (LP-WUS) in a set of symbols, wherein the set of symbols includes a first subset of the set of symbols and a second subset of the set of symbols occurring after the first subset of the set of symbols, wherein control information is conveyed starting at the second subset of the set of symbols, wherein the LP-WUS is a first type of modulation signal for reception by a first type of radio; and
communicate, using a second type of modulation signal for reception by a second type of radio, in accordance with the LP-WUS.

14. The network node of claim 13, wherein the first subset of symbols, of the set of symbols, comprises one or more non-control symbols.

15. The network node of claim 14, wherein the one or more non-control symbols are reserved for gain control.

16. The network node of claim 13, wherein a resource allocation for the LP-WUS starts at a first symbol and a resource allocation for control information of the LP-WUS starts at a second symbol occurring after the first symbol.

17. The network node of claim 13, wherein the first type of modulation signal is an on-off keying (OOK) modulated signal for reception by a low-power wake-up radio (LP-WUR).

18. The network node of claim 13, wherein the second type of modulation signal is a non on-off keying (non-OOK) modulated signal for reception by a main radio.

19. The network node of claim 13, wherein a first waveform of at least one first symbol, of the first subset of the set of symbols, and a second waveform of at least one second symbol, of the second subset of the set of symbols, are the same waveform.

20. A method of wireless communication performed by a user equipment (UE), comprising:
receiving, using a low-power wake-up radio (LP-WUR), a low-power wake-up signal (LP-WUS) in a set of symbols, wherein the set of symbols includes a first subset of the set of symbols and a second subset of the set of symbols occurring after the first subset of the set of symbols, wherein control information is conveyed starting at the second subset of the set of symbols; and
communicating, using a main radio, in accordance with the LP-WUS.
